(19) United States
(12) Patent Application Publication
(10) Pub. No.: US 2013/0036443 A1
(43) Pub. Date: Feb. 7, 2013

(54) INTERACTIVE AND PROGRAM HALF-SCREEN

(71) Applicants: Venket S. Kandanala, Highland Village, TX (US); Nicky Pinakin Joshi, Flower Mound, TX (US); Anand N. Sankaran, MGR Nagar (IN); Rajesh Narayanan, Virugambakkam (IN); Lisa A. Caputo, Dade City, FL (US); Karthik Srinivasan, Flower Mound, TX (US); Mousumi Dasgupta, Irving, TX (US); Jubish C. Parambath, Madipakkam (IN); Sudharsan Selvakumar, Irving, TX (US)

(72) Inventors: Venket S. Kandanala, Highland Village, TX (US); Nicky Pinakin Joshi, Flower Mound, TX (US); Anand N. Sankaran, MGR Nagar (IN); Rajesh Narayanan, Virugambakkam (IN); Lisa A. Caputo, Dade City, FL (US); Karthik Srinivasan, Flower Mound, TX (US); Mousumi Dasgupta, Irving, TX (US); Jubish C. Parambath, Madipakkam (IN); Sudharsan Selvakumar, Irving, TX (US)

(73) Assignee: VERIZON PATENT AND LICENSING INC., Basking Ridge, NJ (US)

(21) Appl. No.: 13/196,949

(22) Filed: Aug. 3, 2011

(51) Int. Cl. H04N 5/445

(52) U.S. Cl. 725/61

(57) ABSTRACT

A method and system that provides a television service via a customer device; receives a customer input to invoke an interactive mode pertaining to the television service; retrieves a graphical user interface that includes an interactive and program half-screen comprising an interactive half-screen and a program half-screen, wherein the interactive half-screen is substantially a same size as a program half-screen, and the interactive half-screen and the program half-screen occupy an entire size of the graphical user interface; and displays the graphical user interface via the customer device, wherein the interactive half-screen includes one or more interactive graphical elements and the program half-screen includes a program window to display a program.

### BACKGROUND

Television services, offered by service providers, typically include a main menu screen that offers various sub-services, such as, video-on-demand, pay-per-view, games, settings, and help. The customers are able to navigate through the main menu screen using a remote control device to access and use these sub-services.

### BRIEF DESCRIPTION OF THE DRAWINGS

FIG. 1 is a diagram illustrating an exemplary environment in which an exemplary embodiment of an interactive and program half-screen may be implemented;

FIG. 2 is a diagram illustrating exemplary components of a device that may correspond to one or more of the devices in the environment depicted in FIG. 1;

FIG. 3 is a diagram illustrating an exemplary graphical user interface including an exemplary interactive and program half-screen;

FIG. 4 is a diagram illustrating an exemplary graphical user interface including an exemplary interactive and program half-screen;

FIG. 5 is a diagram illustrating another exemplary graphical user interface including an exemplary interactive and program half-screen;

FIG. 6 is a diagram illustrating another exemplary graphical user interface including an exemplary interactive and program half-screen; and

FIG. 7 is a flow diagram illustrating an exemplary process associated with the interactive and program half-screen.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

The term “program” includes audio and/or visual content. For example, a program may include a television program (e.g., a movie, a television series, the news, etc.) or Internet content.

According to an exemplary embodiment, a screen includes a half-screen format in which one half of the screen displays a program and the other half of the screen is an interactive screen. According to an exemplary embodiment, each half-screen occupies 50% of the total size of the graphical user interface. According to another embodiment, each half-screen is approximately 50% (e.g., one half-screen is 52% and the other half-screen is 48%, or some other variation within a 5% range).

According to an exemplary embodiment, the interactive screen may pertain to program offers or service-related offers. The program offers include, for example, video-on-demand events, pay-per-view events, and/or television packages or channels (e.g., premium program packages, sports packages, etc.). According to an exemplary embodiment, the program offers are recommended programs based on previous customer behavior. For example, the selection of recommended programs is based on previous purchases, viewing behavior, and/or account profile information associated with a customer. Additionally, the selection of recommended programs may be based on a tiered set of rules related to the customer and/or marketing preferences.

According to another example, the service-related offers include service bundling (e.g., television service and Internet service, etc.), new features provided via an existing service, etc.

In contrast to a typical menu or other type of interactive screens in which the program window is small relative to the remainder portion of the screen, according to an exemplary embodiment, the screen uses the available screen space such that the program window is more balanced in size relative to the remainder portion of the screen.

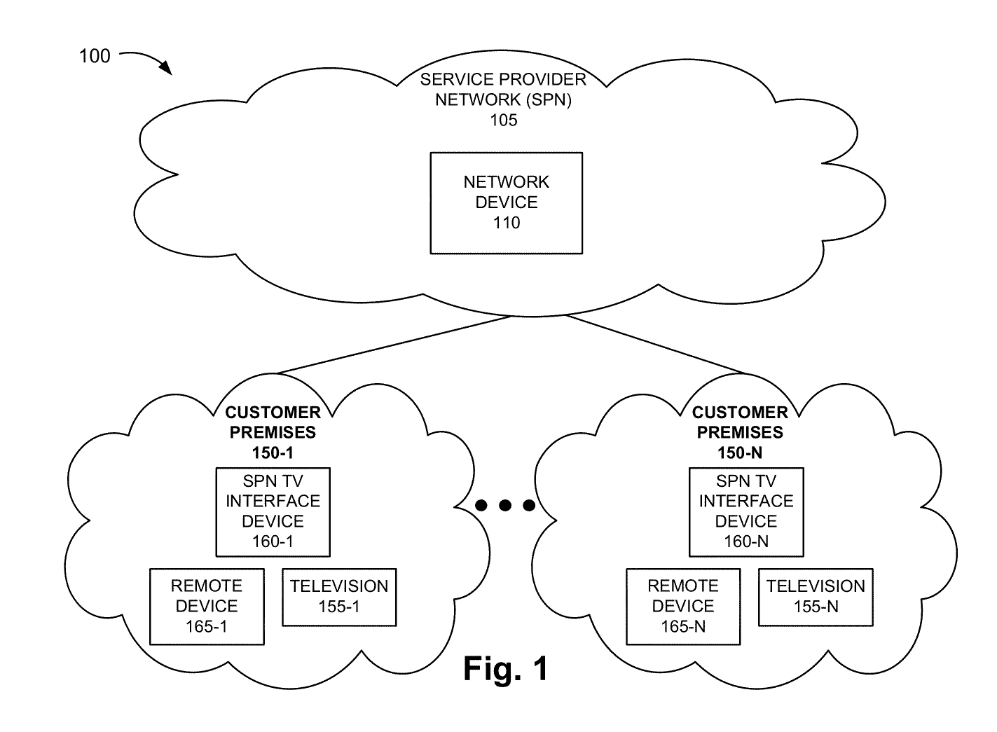

FIG. 1 is a diagram illustrating an exemplary environment 100 in which an exemplary embodiment of the interactive and program half-screen may be implemented. As illustrated in FIG. 1, environment 100 may include a service provider network (SPN) 105 and customer premises 150-1 through 150-N (referred to generally as customer premises 150). Service provider network 105 includes, among other devices, a network device 110. Customer premises 150 includes, among other devices, televisions (TVs) 155-1 through 155-N (referred to generally as TV 155 or TVs 155), SPN TV interface devices 160-1 through 160-N (referred to generally as SPN TV interface device 160 or SPN TV interface devices 160), and remote devices 165-1 through 165-N (referred to generally as remote device 165 or remote devices 165).

The number of devices and networks, and the configuration in environment 100 are exemplary and provided for simplicity. In practice, according to other embodiments, environment 100 may include additional devices, fewer devices, different devices, and/or differently arranged devices, than those illustrated in FIG. 1.

According to other embodiments, a single device may be implemented as multiple devices and/or multiple devices may be implemented as a single device. For example, although television 155 and SPN TV interface device 160 are illustrated as separate devices, television 155 and SPN TV interface device 160 may be combined into a single device. A device may be implemented in a centralized or distributed fashion. Additionally, a device may be implemented according to various architectures (e.g., a client device, a server device, a peer device, or a combination thereof).

Additionally, or alternatively, in practice, environment 100 may include additional networks and/or differently arranged networks, than those illustrated in FIG. 1. For example, customer premises 150 may include a local area network (LAN) and/or other types of networks may be included in environment 100, such as a network provider network, a content provider network, the Internet, etc.

Also, according to other embodiments, one or more functions and/or processes described as being performed by a particular device may be performed by a different device, or some combination of devices. By way of example, one or more functions and/or processes described as being performed by network device 110 may be performed by SPN TV interface device 160, or vice versa, or in combination. Additionally, or alternatively, one or more functions and/or processes described as being performed by network device 110 may be performed by SPN TV interface device 160 or vice versa, or in combination. Environment 100 may include wired and/or wireless connections among the devices illustrated. By way of example, customer premises 150 may connect to service provider network 105 via optical fiber, cable, etc.

Service provider network 105 includes a network that distributes or makes available television service. Service provider network 105 may correspond to a satellite-based network and/or a terrestrial-based network. Although not illustrated, service provider network 105 may include, for example, program distribution devices, program storage devices, application servers, billing devices, security devices, etc. Service provider network 105 may also provide other types of services to customers, such as Internet service and/or mobile service. According to an exemplary embodiment, customers may have access to the interactive and program half-screen, as described herein, via such services (e.g., Internet service, mobile service) when using suitable customer devices (e.g., a desktop computer, a laptop computer, a mobile device (e.g., a smartphone, a tablet device, etc.), a vehicle-based device (e.g., a vehicle communication system), etc.).

Network device 110 includes one or multiple network devices that provide the interactive and program half-screen to customers, as described herein. Network device 110 may take the form of a computational device (e.g., a Web server, a server, an application server, a computer). According to an exemplary embodiment, network device 110 may store an interactive programming guide, other menus (e.g., a main menu and other sub-menus (e.g., video-on-demand, pay-per-view, games, widgets, settings, help, digital video recorder (DVR), television listings, messages, etc.)), and the interactive and program half screen that is accessible to customers via their television service. The interactive and program half-screen is described further below.

Customer premises 150 include locations where customers receive service from service provider network 105. For example, customers may receive services at home, at work, or at locations when the customers are mobile. Customer premises 150 include devices that allow customers to receive television service including the interactive and program half-screen. For example, in a home setting, customer premises 150 may include TVs 155, SPN TV interface devices 160, and remote devices 165. Additionally, according to another embodiment, customer premises 150 may include various devices to allow customers to use the interactive and program half-screen via Internet service and/or mobile service, as described herein.

TV 155 may include a device to display PPV programs. According to an exemplary embodiment, TV 155 may correspond to a television. According to other embodiments, TV 155 may correspond to other types of display devices, such as, for example, a monitor, a mobile device having a display, etc. According to an exemplary embodiment, TV 155 and SPN TV interface device 160 may be separate devices, as illustrated in FIG. 1. According to other embodiments, TV 155 may include SPN TV interface device 160 or include some of the functionalities associated with SPN TV interface device 160.

SPN TV interface device 160 may include a device that communicates with service provider network 105 to provide television service including the interactive and program half-screen. According to an exemplary embodiment, SPN TV interface device 160 may take the form of a client device, a thin client device, a set-top box, a converter box, a receiver device, a server device, a peer device, a tuner device, and/or a digibox. According to an exemplary embodiment, SPN TV interface device 160 may also include a digital video recorder (DVR) and/or a hard drive. SPN TV interface device 160 may also provide multi-room television services.

Remote device 165 may include a device that communicates with TV 155 and/or SPN TV interface device 160 to allow a customer to interact with SPN TV interface device 160 and/or TV 155. Remote device 165 may include one or multiple input mechanisms (e.g., buttons, a display, a touchpad, a touchscreen, a microphone, etc.) to receive a customer's input and, among other things, allow the customer to interact with SPN TV interface device 160. According to an exemplary embodiment, remote device 165 may correspond to a remote control device (e.g., a set-top box controller, a TV controller, a converter box controller, etc.).

According to other embodiments, remote device 165 may correspond to other types of devices. For example, remote device 165 may take the form of a tablet device, a mobile communication device, a personal digital assistant (PDA), a handheld device, a smartphone, or some other type of user device. According to still other embodiments, remote device 165 may include TV 155. According to yet other embodiments, remote device 165 may include TV 155 and SPN TV interface device 160 or include some of the functionalities associated with SPN TV interface device 160.

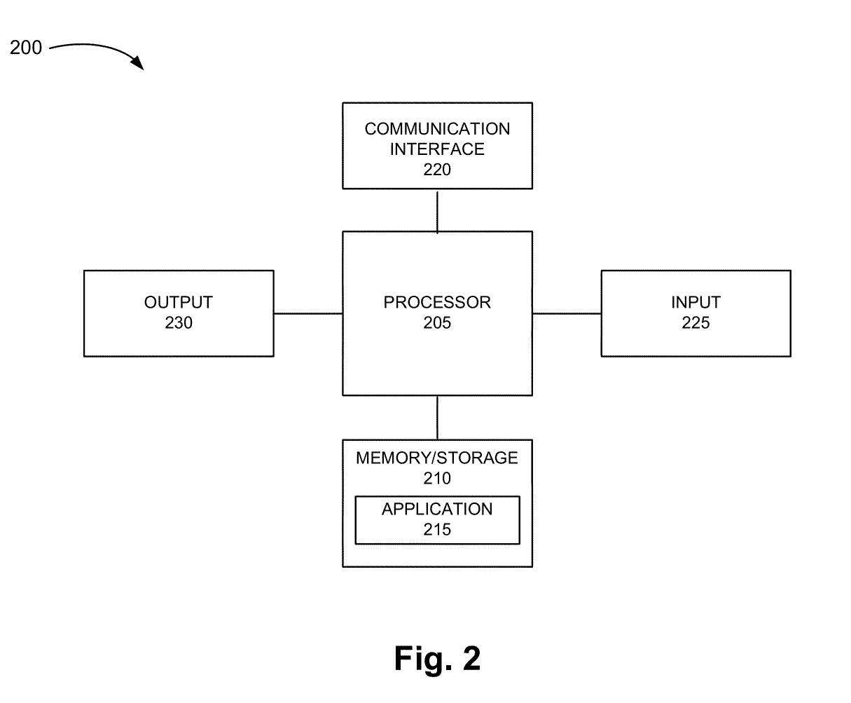

FIG. 2 is a diagram illustrating exemplary components of a device 200 that may correspond to one or more of the devices in environment 100. For example, device 200 may correspond to network device 110 and/or one or more devices in customer premises 150. As illustrated, according to an exemplary embodiment, device 200 may include a processor 205, memory/storage 210 including an application 215, a communication interface 220, an input 225, and an output 230. According to other embodiments, device 200 may include fewer components, additional components, different components, and/or a different arrangement of components than those illustrated in FIG. 2 and described herein.

Processor 205 may include one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (e.g., one or multiple cores), microcontrollers, and/or some other type of component that interprets and/or executes instructions and/or data. Depending on the type of processor 205, processor 205 may be implemented as hardware (e.g., a microprocessor, etc.), a combination of hardware and software (e.g., a SoC, etc.), may include one or multiple memories (e.g., memory/storage 210), etc.

Processor 205 may control the overall operation or a portion of operation(s) performed by device 200. Processor 205 may perform one or multiple operations based on an operating system and/or various applications (e.g., application 215). Processor 205 may access instructions from memory/storage 210, from other components of device 200, and/or from a source external to device 200 (e.g., a network, another device, etc.).

Memory/storage 210 may include one or multiple memories and/or one or multiple other types of tangible storage mediums. For example, memory/storage 210 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a phase-change memory (PCM), a dual in-line memory module (DIMM), a flash memory, and/or some other type of memory. Memory/storage 210 may include a hard disk (e.g., a magnetic disk, an optical disk, a magneto-optic disk, a solid state disk, etc.) a floppy disk (e.g., a zip disk, etc.), a tape, a Micro-Electromechanical System (MEMS)-based storage medium, and/or a nanotechnology-based storage medium. Memory/storage 210 may include drives for reading from and writing to the tangible storage medium.

Memory/storage 210 may be external to and/or removable from device 200, such as, for example, a Universal Serial Bus (USB) memory stick, a dongle, a hard disk, mass storage, off-line storage, or some other type of storing medium (e.g., a computer-readable medium, a compact disk (CD), a digital versatile disk (DVD), a Blu-Ray® disk (BD), etc.). Memory/storage 210 may store data, application(s), and/or instructions related to the operation of device 200.

Application 215 may include software or a program that provides various services and/or functions. For example, with reference to network device 110 and according to an exemplary embodiment, application 215 may include one or multiple applications or programs for providing the half-screens, as described herein.

Communication interface 220 may permit device 200 to communicate with other devices, networks, systems, etc. Communication interface 220 may include one or multiple wireless interfaces and/or wired interfaces. Communication interface 220 may include one or multiple transmitters, receivers, and/or transceivers. Communication interface 220 may operate according to one or multiple protocols, standards, and/or the like.

Input 225 may permit an input into device 200. For example, input 225 may include a keyboard, a mouse, a camera, a scanner, a microphone, a display, a touchpad, a touchscreen, a touchless screen, a button, a switch, an input port, voice recognition logic, speech recognition logic, fingerprint recognition logic, a web cam, and/or some other type of visual, auditory, tactile, etc., input component. Output 230 may permit an output from device 200. For example, output 230 may include a speaker, a display, a touchscreen, a touchless screen, a light, an output port, and/or some other type of visual, auditory, tactile, etc., output component.

Device 200 may perform processes and/or functions, as described herein, in response to processor 205 executing instructions (e.g., application 215) stored by memory/storage 210. By way of example, the instructions may be read into memory/storage 210 from another memory/storage 210 or from another device via communication interface 220. The instructions stored by memory/storage 210 may cause processor 205 to perform one or more processes described herein. Alternatively, for example, according to other implementations, device 200 may perform one or more processes described herein based on the execution of hardware (processor 205, etc.), the execution of hardware and firmware, or the execution of hardware, software, and firmware.

As previously described, a screen includes a half-screen format in which one half of the screen includes displaying a program and the other half of the screen includes displaying program offers and/or service-related offers via an interactive interface. Examples of the interactive and program half-screen are described below.

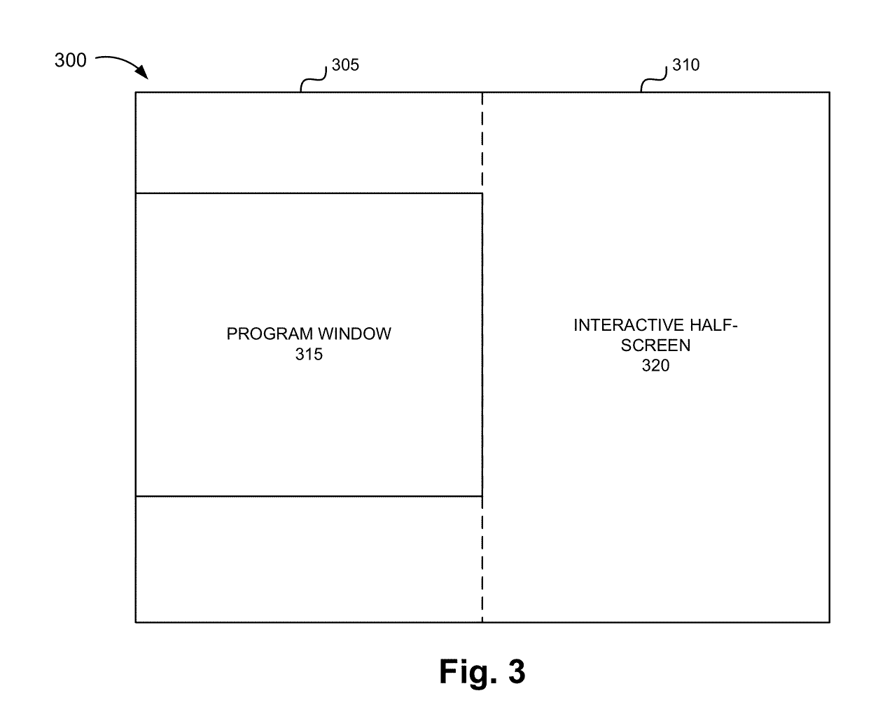

FIG. 3 is a diagram illustrating an exemplary graphical user interface including an exemplary interactive and program half-screen 300. As illustrated, interactive and program half-screen 300 includes a first half-screen 305 and a second half-screen 310. First half-screen 305 includes a program window 315 that displays a particular program being aired, for example, on a television channel. According to an exemplary embodiment, program window 315 has a size of approximately 35% of the available screen space. According to another embodiment, program window 315 has a size of approximately 40% or greater, but not more than approximately 50%.

Second half-screen 310 includes an interactive half-screen 320. Interactive half-screen 320 includes one or multiple interactive graphical elements (e.g., menu, icon, etc.), a prompt to select or press a button via remote device 165, etc. Interactive half-screen 320 may also include text and/or one or multiple images. According to an exemplary embodiment, interactive half-screen 320 includes program offers and/or service-related offers. According to another embodiment, first half-screen 305 and second half-screen 310 may be located on different sides of the screen.

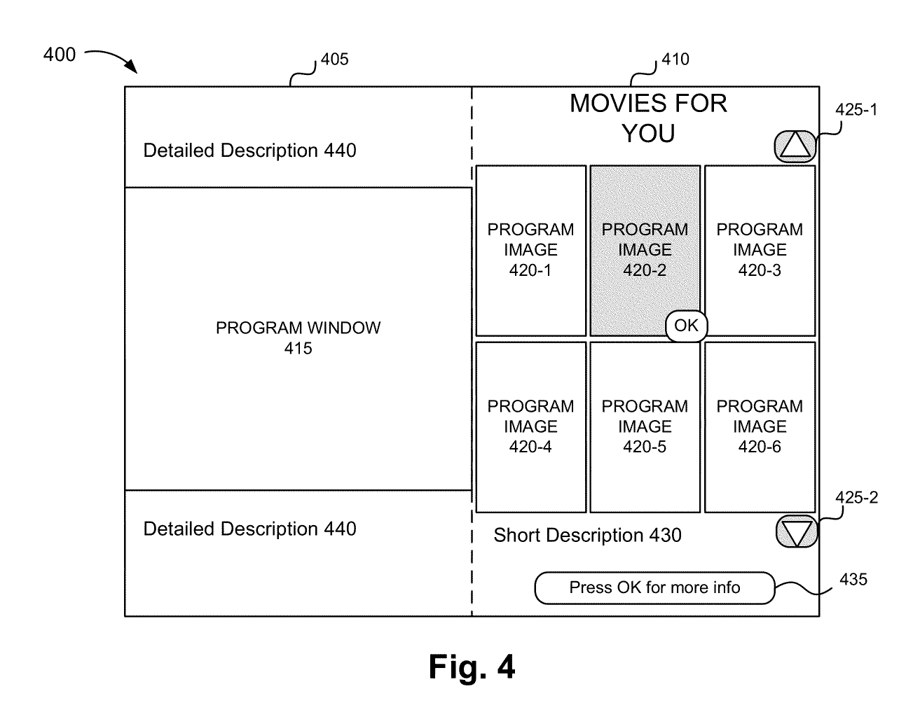

FIG. 4 is a diagram illustrating an exemplary graphical user interface that includes an exemplary interactive and program half-screen 400. As illustrated, interactive and program half-screen 400 includes a first half-screen 405 and a second half-screen 410. According to this example, second half-screen 410 pertains to a program offer.

First half-screen 405 includes a program window 415 that displays a particular television program based on the television channel. Second half-screen 410 includes program images 420-1 through 420-6 (referred to program images 420 or program image 420). As illustrated, program images 420 have a 3×2 grid format. In this example, program images 420 are representative of movies (e.g., video-on-demand movies). A customer is able to navigate and select any of the six program images 420 via, for example, remote device 165.

According to an exemplary embodiment, program images 420 are representative of movies that are being recommended. As previously described, the recommendations are based on previous purchases, viewing behavior, and/or account profile information. Additionally, recommendations may be based on a tiered set of rules related to the customer and/or marketing preferences. By way of example, the set of rules may include rules pertaining to aggregated purchase behavior and analysis of a particular program (e.g., sports type, movie genre, etc.); location centric information of customers (e.g., at street level, zip code level, state, city, and/or county level); and time information (e.g., day of the week, week of the month, time of the day, etc.). The set of rules may also include affinity rules that pertain to customers buying a particular program and having an affinity to buy a similar program, and exclusionary rules that pertain to excluding programs from recommendation based on various factors. For example, the customer may have already purchased the program, the customer's history indicates previous exposure to the recommended program but no interest, a customer preference includes content filtering that prohibits particular types of programs, etc.

Additionally, according to this example, second half-screen 410 includes an up-arrow 425-1 and a down-arrow 425-2 to permit the customer to display an additional set of program images 420. Below program images 420, a short description pertaining to a selected program image 420 is provided. For example, when the customer selects program image 420-2, a short description 430 pertaining to the movie represented by program image 420-2 is displayed. The short description may include the director of the movie, starring actor(s) in the movie, etc.

As further illustrated, second half-screen 410 includes an interactive element 435 to permit the customer to obtain more information pertaining to the selected program image 420-2.

According to an exemplary embodiment, first half-screen 405 also includes information and/or an interactive element pertaining to the movie. For example, any remaining screen space not occupied by program window 415 may be used. According to another exemplary embodiment, first half-screen 405 does not include information and/or an interactive element pertaining to the movie. In this example, first half-screen 405 includes detailed description 440 pertaining to the movie represented by program image 420-2 located both above and below program window 415. As an example, detailed description 440 may include a Title caption of the movie represented by program image 420, movie summary, one or multiple images, user ratings, etc.

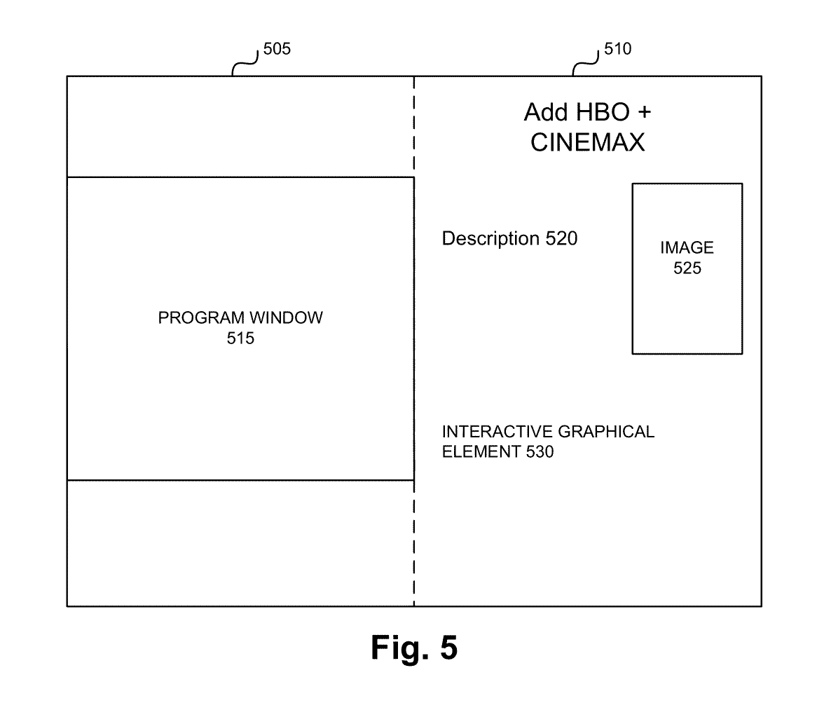

FIG. 5 is a diagram illustrating another exemplary graphical user interface that includes an interactive and program half-screen 500. As illustrated, interactive and program half-screen 500 includes a first half-screen 505 and a second half-screen 510. According to this example, second half-screen 510 pertains to a service-related offer.

First half-screen 505 includes a program window 515 that displays a particular television program based on the television channel. Second half-screen 510 includes a description 520, an image 525, and an interactive graphical element 530.

Description 520 includes text describing the service-related offer. In this example, description 520 may describe information for adding a HBO® and Cinemax® bundle. Image 525 includes one or multiple pictures. In this example, image 525 may include program posters of programs (e.g., a movie, a series, etc.) available on HBO and Cinemax. Interactive graphical element 530 may permit the customer to obtain additional information, access free HBO and Cinemax programs, purchase the bundle, etc.

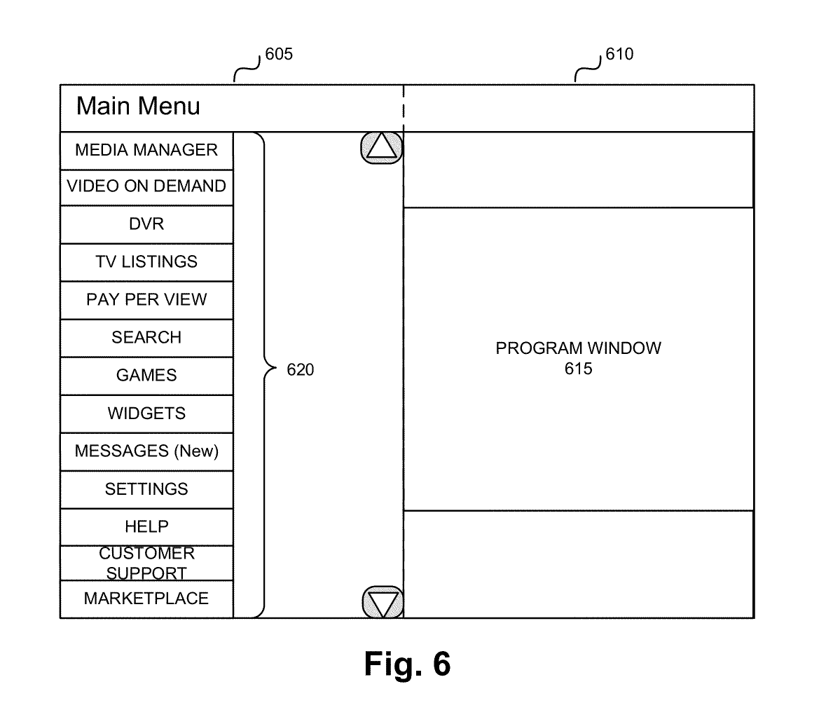

While the embodiments described above include an interactive half-screen that pertains to a program offer or a service offer, other embodiments may pertain to other aspects of a television service. For example, a television service may provide customers with a main menu screen. FIG. 6 illustrates an exemplary main menu screen. As illustrated, the exemplary graphical user interface includes a first half-screen 605 and a second half-screen 610. Second half-screen 610 includes a program window 615. First half-screen 605 includes sub-menus 620 that are accessible via a main menu screen. In this example, sub-menus 620 include media manager, video-on-demand, digital video recorder, TV listings, pay-per-view, search, games, widgets, messages, settings, help, customer support, and marketplace. According to an exemplary embodiment, when a customer accesses one of sub-menus 620, a graphical user interface having the interactive and program half-screen format may be displayed. An interactive half-screen includes information, images, and interactive graphical elements pertaining to one of sub-menus 620. By way of example and with reference to the customer support sub-menu, the interactive half-screen may include information, images, and interactive graphical elements pertaining to customer support.

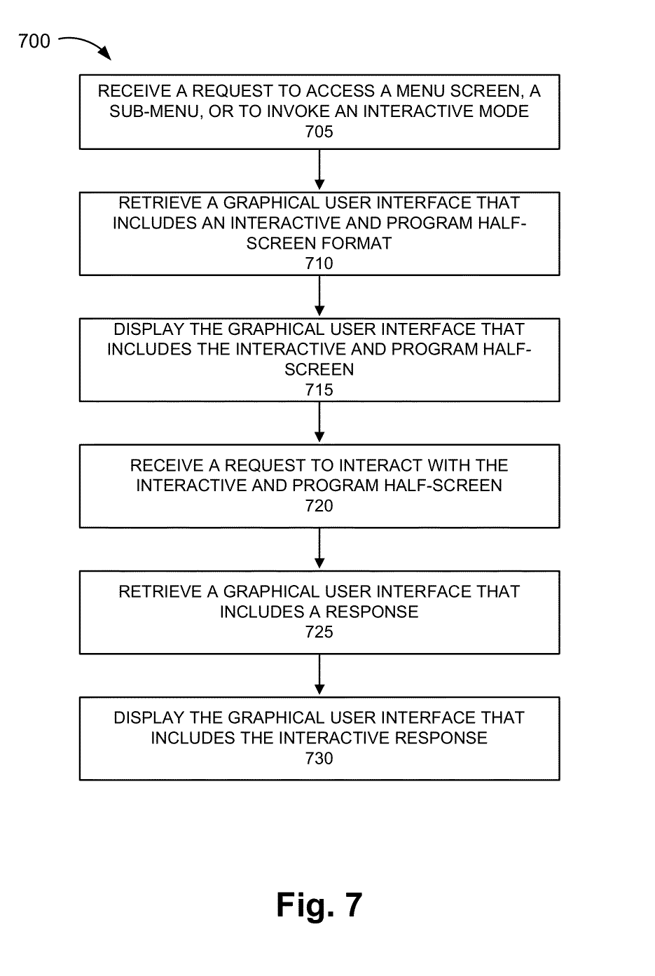

FIG. 7 is a flow diagram illustrating an exemplary process 700 associated with the interactive and program half-screen. According to an exemplary embodiment, network device 110 may perform one or more steps described in process 700. For example, processor 205 may execute an application 215 to perform the steps described.

Referring to FIG. 7, in block 705, a request to access a menu screen, a sub-menu screen, or to invoke an interactive mode is received. For example, a customer invokes the request via remote device 165 and SPN TV interface device 160. As an example, remote device 165 may include an input (e.g., a menu button, a sub-menu button, or an interactive mode button) to generate the request. Network device 110 receives the request to access the menu screen, the sub-menu screen, or to invoke the interactive mode via SPN TV interface device 160.

In block 710, a graphical user interface that includes an interactive and program half-screen format is retrieved. For example, network device 110 retrieves the graphical user interface that includes the interactive and program half-screen based on the request. Network device 110 provides the graphical user interface that includes the interactive and program half-screen to SPN TV interface device 160.

In block 715, the graphical user interface that includes the interactive and program half-screen is displayed. For example, SPN TV interface device 160 displays the graphical user interface that includes interactive and program half-screen 300 via television 155. Interactive half-screen 320 includes an interactive element and information and/or images pertaining to programs, a service, or a sub-menu 620. According to some embodiments, half-screen 305 that includes program window 315 may also include an interactive element.

In block 720, a request to interact with the interactive and program half-screen is received. For example, the customer invokes the request via remote device 165 and SPN TV interface device 160. Network device 110 receives the request via SPN TV interface device 160.

In block 725, a graphical user interface that includes a response is retrieved. For example, network device 110 retrieves the graphical user interface that includes the response based on the request. Network device 110 provides the graphical user interface that includes the response to SPN TV interface device 160.

As previously described, the interactive and program half-screen may pertain to a program offer, a service-related offer, and/or sub-menus (e.g., sub-menus 620). Thus, the response may include various information, images, and/or interactive elements pertaining to the program offer, the service-related offer, and/or the sub-menus.

In block 730, the graphical user interface that includes the response is displayed. For example, SPN TV interface device 160 displays the graphical user interface that includes the response via television 155. According to an exemplary embodiment, the graphical user interface may include another interactive and program half-screen.

According to other embodiments, one or more blocks illustrated in FIG. 7 and described as being performed by a device may be performed by another device. For example, SPN TV interface device 160 may load and store an interactive and program half-screen, based on a communication with network device 110, when the customer turns on the SPN TV interface device 160 and uses a television service.

The foregoing description of embodiments provides illustration, but is not intended to be exhaustive or to limit the embodiments to the precise form disclosed. Accordingly, modifications to the embodiments described herein may be possible.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while a series of blocks has been described with regard to the process illustrated in FIG. 7, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software, firmware, and/or hardware. For example, a process or a function may be implemented as “logic” or as a “component.” This logic or this component may include hardware (e.g., processor 205, etc.), a combination of hardware and software (e.g., application 215), a combination of hardware and firmware, or a combination of hardware, firmware, and software. The embodiments have been described without reference to the specific software code since software can be designed to implement the embodiments based on the description herein.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

No element, act, or instruction described in the present application should be construed as critical or essential to the embodiments described herein unless explicitly described as such.

What is claimed is:

1. A method comprising:
providing a television service via a customer device;
receiving a customer input to invoke an interactive mode pertaining to the television service including access to a menu screen or a sub-menu screen;
retrieving a graphical user interface that includes an interactive and program half-screen comprising an interactive half-screen and a program half-screen, wherein the interactive half-screen is substantially a same size as a program half-screen, and the interactive half-screen and the program half-screen occupy an entire space of the graphical user interface;
displaying the graphical user interface via the customer device, wherein the interactive half-screen includes one or more interactive graphical elements and the program half-screen includes a program window to display a program;
receiving another customer input to access another graphical user interface;
retrieving the other graphical user interface; and
displaying the other graphical user interface via the customer device, wherein the other graphical user interface includes another interactive and program half-screen.

2. The method of claim 1, wherein the graphical user interface is the menu screen.

3. The method of claim 1, wherein a size of the program window is approximately thirty-five percent of the entire size of the graphical user interface.

4. The method of claim 1, wherein the interactive half-screen includes at least one of one or more images representative of one or more programs or descriptive information pertaining to at least one of the one or more programs.

5. The method of claim 1, wherein the interactive half-screen includes a customer recommendation of programs, wherein the customer recommendation includes one or more images representative of one or more programs and each of the one or more programs pertains to one of a pay-per-view event, a video-on-demand event, a free preview of a channel, or a television package.

6. The method of claim 1, wherein the menu screen includes a main menu screen, and wherein the sub-menu screen pertains to one of video-on-demand, digital video recorder, pay-per-view, games, widgets, settings, help, customer support, searching, or television listings.

7. The method of claim 1, wherein the program half-screen includes at least one of one or more images pertaining to one or more programs or descriptive information pertaining to at least one of the one or more programs, and the one or more images or the descriptive information is located above or below the program window.

8. The method of claim 1, wherein the interactive half-screen includes images representative of recommended programs.

9. A device comprising:
a communication interface;
one or more memories that store instructions; and
one or more processors to execute the instructions and configure the one or more processors to:
provide a television service;
receive a customer input to invoke an interactive mode pertaining to the television service including access to a menu screen or a sub-menu screen;
obtain the graphical user interface that includes an interactive and program half-screen comprising an interactive half-screen and a program half-screen, wherein the interactive half-screen is substantially a same size as a program half-screen, and the interactive half-screen and the program half-screen correspond to an entire size of the graphical user interface; and
output the graphical user interface, wherein the interactive half-screen includes one or more interactive graphical elements and the program half-screen includes a program window to display a program.

10. The device of claim 9, wherein the one or more processors further execute the instructions and configure the one or more processors to:
receive another customer input to access another graphical user interface;
obtain the other graphical user interface; and
output the other graphical user interface, wherein the other graphical user interface includes another interactive and program half-screen.

11. The device of claim 9, wherein a size of the program window is between thirty-five percent and forty-five percent of the entire size of the graphical user interface.

12. The device of claim 9, wherein the interactive half-screen includes at least one of one or more images representative of one or more programs or descriptive information pertaining to at least one of the one or more programs.

13. The device of claim 9, wherein the interactive half-screen includes a customer recommendation of programs, wherein the customer recommendation includes one or more images representative of one or more programs and each of the one or more programs pertains to one of a pay-per-view event, a video-on-demand event, a free preview of a channel, or a television package.

14. The device of claim 9, wherein the menu screen includes a main menu screen, and wherein the sub-menu screen pertains to one of video-on-demand, digital video recorder, pay-per-view, games, widgets, settings, help, customer support, searching, or television listings.

15. The device of claim 9, wherein the interactive half-screen includes images, in a 3×2 format, representative of recommended programs.

16. A method comprising:
receiving an input request to invoke an interactive mode pertaining to a television service that includes a graphical user interface of a menu screen or a sub-menu screen;
storing the graphical user interface;
identifying the graphical user interface based on the received input request;
transmitting the graphical user interface to a customer device; and
displaying the graphical user interface, wherein the graphical user interface includes an interactive and program half-screen comprising an interactive half-screen and a program half-screen each being substantial a same size and in combination corresponding to an entire size of the graphical user interface, wherein the interactive half-screen includes one or more graphical elements that are interactive and the program half-screen includes a program window to display a program.

17. The method of claim 16, further comprising:
receiving another input request to access another graphical user interface;
storing the other graphical user interface;
identifying the other graphical user interface based on the received other input request;
transmitting the other graphical user interface to the customer device; and
displaying the other graphical user interface, wherein the other graphical user interface includes another interactive and program half-screen.

18. The method of claim 16, wherein the interactive half-screen includes at least one of one or more images representative of one or more programs or descriptive information pertaining to at least one of the one or more programs.

19. The method of claim 16, wherein the menu screen includes a main menu screen, and wherein the sub-menu screen pertains to one of video-on-demand, digital video recorder, pay-per-view, games, widgets, settings, help, customer support, searching, or television listings.

20. The method of claim 16, wherein the program half-screen includes at least one of one or more images pertaining to one or more programs or descriptive information pertaining to at least one of the one or more programs, and the one or more images or the descriptive information is located above or below the program window.
